(19) United States
(12) Patent Application Publication
(10) Pub. No.: US 2010/0119280 A1
(43) Pub. Date: May 13, 2010

(54) LABEL PRINTER

(75) Inventor: Kris Vandermeulen, Bornem (BE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: DYMO, Sint-Niklaas (BE)

(21) Appl. No.: 12/594,607

(22) PCT Filed: Apr. 7, 2008
(86) PCT No.: PCT/EP2008/054174

§ 371 Date: Oct. 13, 2009

(30) Foreign Application Priority Data
Apr. 5, 2007 (GB) 0706786.1

(51) Int. Cl. B41J 35/28

(52) U.S. Cl. 400/208

(57) ABSTRACT

A label printer includes a cassette-receiving bay having a base, a top opening, and side walls. A cover member is provided on the cassette-receiving bay, movable between open and closed positions. One of the print head and the platen roll being operatively connected to the cover member such that the print head and the platen roll are in the inoperative position when the cover member is open. An ejector mechanism is provided, including an ejector element movable in a direction towards the base by a cassette and biased in a direction towards the top opening for ejecting the cassette. The print head and the platen roll can be prevented from being moved into the operative position when the cover member is closed and no cassette is inserted in the cassette-receiving bay.

### FIELD OF THE DISCLOSURE

The present disclosure relates to a label printer, and particularly to a cassette ejection mechanism for a label printer.

### BACKGROUND OF THE DISCLOSURE

Label printers are known, which use a supply of tape, housed in a cassette, received in the label printer. The tape comprises an image receiving layer and a backing layer which are secured to one another via an adhesive layer. Such label printers include a cutting mechanism for cutting off a portion of the tape after an image has been printed onto the image-receiving layer so that the portion of tape having the image can be used as a label. After the tape has been cut, the cut portion of the tape is pulled from the printer through a slit in the printer housing. The backing layer can then be removed allowing the image-receiving layer to be secured to an object using the adhesive layer.

Known label printers comprise a cassette-receiving bay in which a cassette is received for printing. A printhead is provided in the cassette-receiving bay for co-operating with the supply of tape to print thereon. A platen may also be provided in the cassette-receiving bay positioned at a side of the tape opposite to the printhead when the cassette is received in the cassette-receiving bay. During printing, the printhead co-operates with the platen, with the tape passing therebetween for printing thereon. The platen may be driven by a motor for propagating the tape during printing. Alternatively, the platen may be freely rotatable and an additional drive roller may be provided for driving the tape during printing.

In an alternative arrangement to that described above, a platen may be provided within the cassette. In such an arrangement, the tape cooperates with a surface of the platen. When received in the cassette-receiving bay the platen in the cassette co-operates with a drive mechanism in the cassette-receiving bay for driving the tape during printing. Alternatively, the platen is freely rotatable and an additional drive roller may be provided for driving the tape. During printing, the printhead in the cassette-receiving bay co-operates with the platen in the cassette with tape passing therebetween for printing thereon.

In one arrangement, the printhead is moveable between a non-printing position and a printing position. In an alternative arrangement, the platen is moveable between a non-printing position and a printing position. In yet another arrangement, both the platen and printhead are movable so as to have non-printing and printing positions.

The tape may be of a direct thermal type on which printing is achieved by direct application of heat from printing elements on the printhead. Alternatively, an ink ribbon may be provided, whereby ink is transferred from the ribbon to an image receiving tape by application of heat to the ink ribbon via printing elements on the printhead. The cassette may include a roll of die cut labels rather than a continuous tape.

EP-A-07940466 (DYMO) discloses a label printer having an openable lid provided on a cassette receiving bay, into which a cassette, containing a tape to be printed, can be inserted. The label printer has a platen and a print head, the printhead being movable into an operative position for printing and to an inoperative position. The lid is coupled to the print head such that when the lid is open, the print head is in the inoperative position. The label printer further comprises a print head stop mechanism which prevents the print head from moving into the operative position when the lid is closed in the event that there is no cassette inserted in the cassette-receiving bay. The print head stop mechanism is actuated by a plunger disposed at the base of the cassette-receiving bay. Accordingly, when a cassette in inserted in the label printer, the plunger is depressed and the print head is permitted to move into the operative position when the lid is closed. However, there is a disadvantage with the above described print head stop mechanism in that a separate actuator must be provided in the cassette receiving bay. This increases the number of components and the complexity of design of the known label printer. Furthermore, with the print head stop mechanism disposed below the cassette-receiving bay, the height of the label printer has to be increased.

Another problem exists in all the above-described arrangements, in that for good quality printing the tape and/or ink ribbon must be correctly aligned with the printhead during printing. Furthermore, the tape must remain correctly aligned with the printhead while printing occurs and must smoothly pass the printhead so as to ensure good quality printing. In order to ensure that this is the case, it is advantageous to prevent the cassette from moving during printing and cutting. Furthermore, the position of the cassette within the cassette-receiving bay should be predefined and readily reproducible whenever a cassette is inserted in the cassette-receiving bay.

The problem is exacerbated in hand held printers which may be moved around during printing. In such an apparatus, it is even more important that the cassette is locked in a fixed position during printing.

WO 2006/013466 (DYMO) discloses a cassette locking and ejecting arrangement for a label printer apparatus. Referring to FIG. 25 of this document a known label printer comprises a cassette-receiving bay in which a tape cassette is inserted. The cassette receiving bay is provided with a plurality of spring-loaded ejecting member for ejecting a cassette from the cassette-receiving bay. When a cassette is inserted in the cassette receiving bay, a pair of locking members hold the cassette in place against the biasing force exerted by the ejecting members. To eject the cassette, the locking members are disengaged from the cassette allowing the cassette to be pushed out of the cassette-receiving bay by the force exerted by the ejecting members.

Typically cassettes for use in such label printers have a low weight. Accordingly, the force of the ejecting members acting on the cassette may cause the cassette to be abruptly and/or violently ejected from the cassette-receiving bay. Thus, there is a risk that a cassette ejected in such a manner will be damaged. Furthermore, there is an increase in the wear on the components of the ejecting mechanisms due to the abrupt movement of the ejecting members.

Referring to FIG. 36 of WO 2006/013466 (DYMO), the pair of locking members are biased, by means of a spring, towards a locking position so as to lock a cassette inserted into the cassette receiving bay in place. However, in the event that the label printer apparatus is subjected to a sudden impact, i.e. if it is dropped by a user, it is possible that the locking members will be moved against the biasing force of the spring so as to release the cassette. Accordingly, when a user subsequently resumes printing with the label printer apparatus, the cassette will not be properly locked in the cassette receiving bay in the correct position for printing, and printing will be adversely effected or impossible.

### SUMMARY OF THE DISCLOSURE

It is an aim of the present disclosure to solve at least some of the problems described above.

According to a first aspect of the present disclosure, there is provided a label printer comprising:
a cassette-receiving bay adapted to receive a cassette which contains an image receiving medium, said cassette-receiving bay having a base, a top opening opposite the base, and side walls extending between the base and the top opening;
a cover member provided on the cassette-receiving bay, said cover member movable between an open and closed position;
a print head and a platen roll, at least one of which is movable relative to the other between an operative position for printing and an inoperative position, wherein one of the print head and the platen roll is operatively connected to said cover member such that the print head and the platen roll are in the inoperative position when the cover member is open;
an ejector mechanism for ejecting a cassette from the cassette-receiving bay, the ejector mechanism comprising an ejector element, the ejector element being movable in a direction towards the base by a cassette inserted into the cassette-receiving bay and biased in a direction towards the top opening for ejecting the cassette; and
stopping means,
wherein said ejector mechanism is operatively coupled to the stopping means for preventing the print head and the platen roll from being moved into the operative position when said cover member is closed and no cassette is inserted in the cassette-receiving bay.

Preferably, one of the print head and the platen roll is mounted on a support means which is movable between a position in which the print head and the platen roll are in the operative position, and a position in which the print head and the platen roll are in the inoperative position, and wherein said stopping means can be brought into a position for restricting the movement of the support means. More preferably, the support means is pivotally mounted about a pivot point. Still more preferably, said stopping means is disposed adjacent to a first end of said support means and said one of the print head and the platen roll is disposed at a second end of the support means, said pivot point being disposed between said first and second ends. Even more preferably, said stopping means is slidably mounted and movable between a first position, in which said stopping means restricts movement of said first end of said support means, and a second position, in which said stopping means does not restrict movement of said first end of said support means. Yet more preferably, the label printer comprises biasing means for biasing said stopping means towards said first position.

Preferably, said ejector element extends from a side wall into the cassette-receiving bay and said ejector mechanism comprises a housing and a biasing mechanism, the housing comprising an elongate opening and the biasing mechanism comprising a biasing member, which extends through said elongate opening, the biasing member being coupled to the ejector element with the housing and coupled to a biasing element outside the housing for biasing the ejecting element; and wherein said stopping member comprises a projecting part, said projecting part arranged so as to operatively couple to said biasing member.

More preferably, said biasing member is coupled to said projecting part so as to bias said stopping member in a direction towards said top opening. Alternatively, said biasing member is coupled to said projecting part so as to bias said stopping member into said position for restricting the movement of the support means.

Preferably, the label printer comprises lever means, said lever means being pivotally mounted at a first end thereof, a second end of said lever means being coupled to said first end of said support means.

More preferably, the label printer comprises elastic means for coupling said second end of said lever means to said first end of said support means.

Preferably, said cover member comprises a plunger part arranged to cause said lever means to pivot in response to the cover member moving from the open position to the closed position.

Preferably, the label printer comprises hook means for releasably hooking onto said lever means to prevent rotational movement thereof. More preferably, the label printer comprises a cassette locking mechanism comprising a locking element arranged so as to extend through an opening in a side wall of said cassette-receiving bay, said locking element movable between a locking position for engagement with a cassette inserted into said cassette-receiving bay and an unlocking position in which said locking element is retracted from the cassette-receiving bay, said locking element being biased towards the locking position, wherein said locking element is further arranged so as to bias said hook means away from said lever means when said locking means is in said unlocking position. Still more preferably, the label printer comprises actuator means for moving said locking element from said locking position into said unlocking position.

According to a second aspect of the present disclosure, there is provided, a label printer comprising:

a cassette-receiving bay, said cassette-receiving bay having a base, a top opening opposite the base, and side walls extending between the base and the top opening;

an ejector mechanism comprising an ejector element extending from a side wall into the cassette-receiving bay and having a free end unconnected to any other structural elements, the ejector element being movable in a direction towards the base by a cassette inserted into the cassette-receiving bay and biased in a direction towards the top opening for ejecting a cassette, wherein the ejector element is coupled to a damper for resisting movement of the ejector element in at least the direction towards the top opening of the cassette receiving bay.

Preferably, said damper resists movement of said ejector element in the direction towards the base of the cassette-receiving bay.

Preferably, the ejector mechanism comprises a rack portion coupled to the ejector element, and each damper comprises a pinion arranged so as to mesh with said rack portion.

Preferably, said ejector mechanism comprises a housing, the housing comprising shaft and a first elongate opening through which the ejector element extends, the ejector element comprising a hole formed therethrough for cooperating with said shaft so as to guide said ejector element along said first elongate opening.

Preferably, said housing comprises a second elongate opening through which said rack portion extends for engagement with said pinion.

Preferably, the label printer comprises a third elongate opening and a biasing mechanism, the biasing mechanism comprising a biasing member coupled to the ejector element within the housing and coupled to a biasing element outside the housing for biasing the ejecting element.

According to a third aspect of the present disclosure, there is provided a label printer comprising a cassette-receiving bay adapted to receive a cassette which contains an image receiving medium, said cassette-receiving bay having a base, a top opening opposite the base, and side walls extending between the base and the top opening, a cover member provided on the cassette-receiving bay, said cover member movable between an open and closed position, a locking mechanism comprising at least one locking element extending into the cassette receiving bay for locking a cassette in the cassette receiving bay, wherein said at least one locking element is movable between a locking position and an unlocked position, and wherein said cover member comprises a first projecting member extending therefrom and arranged so as to be disposed adjacent to said at least one locking element when said cover is in said closed position, thereby preventing said locking element from being moved to the unlocked position when said cover is in said closed position.

Preferably, said at least one locking element extends through a side wall of the cassette receiving bay.

Preferably, the label printer comprises a surface extending substantially perpendicular to the sidewalls of the cassette receiving bay, said surface comprising an opening therein for receiving said projecting member when said cover member is in said closed position.

Preferably, the label printer comprises two locking elements extending into the cassette-receiving bay for locking a cassette in the cassette-receiving bay, wherein each locking element is moveable between a locking position and an unlocked position, the two locking elements being linked by an actuator mechanism positioned below the base of the cassette-receiving bay so as to synchronise movement of the two locking elements, and wherein said cover member comprises a second projecting member arranged such that each of the first and second projecting members are disposed adjacent to respective locking elements when said cover is in said closed position, thereby preventing said locking elements from being moved to the unlocked position when said cover is in said closed position.

Preferably, a printing system is provided which comprises a label printer as claimed in any one of claims 1 to 25 below and a label cassette.

### BRIEF DESCRIPTION OF THE DRAWINGS

For a better understanding of the present disclosure and to show how the same may be carried into effect, embodiments of the present disclosure will now be described by way of example only with reference to the accompanying drawings, in which:

FIG. 1 is a top perspective view of an embodiment of a label printer according to the present disclosure, the label printer having its lid open and no cassette present;

FIG. 2 is another top perspective view of the label printer shown in FIG. 1;

FIG. 3 is a view illustrating the position of a first locking element of the label printer shown in FIG. 1;

FIG. 4 is a view illustrating the position of a first ejector element of the label printer shown in FIG. 1

FIG. 5 is a view illustrating the position of a second locking element of the label printer of FIG. 2;

FIG. 6 is a view illustrating the position of a second ejector element of the label printer shown in FIG. 2;

FIG. 7 is a top perspective view of the label printer of FIG. 1 illustrating the positions of a first locking element and a first ejector element with a cassette installed in the cassette-receiving bay (the cassette is not shown for clarity);

FIG. 8 is another top perspective view of the label printer shown in FIG. 7;

FIG. 9 is a view illustrating the position of the first locking element shown in FIG. 3 during insertion/ejection of a cassette;

FIG. 10 is a view illustrating the position of the first ejector element shown FIG. 4 during insertion/ejection of a cassette;

FIG. 11 is a view illustrating the positions of the second locking element and the second ejector element shown in FIG. 5 during insertion/ejection of a cassette;

FIG. 12 is a view illustrating the position of the third ejector element shown in FIG. 6 during insertion/ejection of a cassette;

FIG. 13 shows a view of the ejector mechanisms and the locking mechanism of the label printer of FIG. 1;

FIG. 14 is a side perspective view of the right hand side of the label printer of FIG. 1, showing an ejector mechanism;

FIG. 15 is a bottom perspective view of the label printer of FIG. 1;

FIG. 16 is a side perspective view of the left hand side of the label printer of FIG. 1, showing a print head stop mechanism according to the present disclosure, when the lid of the label printer is open and no cassette is inserted;

FIG. 17 is an enlarged side/rear perspective view of the label printer of FIG. 1, showing the print head stop mechanism of FIG. 16 and an ejector mechanism;

FIG. 18 is a view of the print head stop mechanism of FIG. 16, when the lid of the label printer is closed and a cassette is inserted;

FIG. 19 is a view of the label printer of FIG. 1, showing the print head stop mechanism of FIG. 16 and an ejector mechanism (various elements of the label printer have been omitted from the Figure for clarity);

FIG. 20 is a view of the label printer of FIG. 1, when viewed from a viewpoint opposite to that of FIG. 19 (various elements of the label printer have been omitted from the Figure for clarity);

FIG. 21 is a perspective view of the print head stop mechanism of the label printer of FIG. 1, when the lid of the label printer is closed and a cassette is inserted (various elements of the label printer have been omitted from the Figure for clarity);

FIG. 22 is a perspective view of the print head stop mechanism of the label printer of FIG. 1, when the lid of the label printer is open and no cassette is inserted (various elements of the label printer have been omitted from the Figure for clarity);

FIG. 23 is a perspective view of the print head stop mechanism of the label printer of FIG. 1, when the lid of the label printer is closed and no cassette is inserted (various elements of the label printer have been omitted from the Figure for clarity);

FIG. 24 is a perspective view of another embodiment of a label printer according to the present disclosure, the label printer having its cover open and no cassette present;

FIG. 25 is an enlarged perspective view of the cover member of the label printer shown in FIG. 24;

FIG. 26 is a perspective view of the label printer shown in FIG. 24, with a cassette inserted;

FIG. 27 is cut away view of the side of the label printer shown in FIG. 24 with a cassette inserted and the cover in the closed position;

FIG. 28 is a perspective view of one end of the label printer shown in FIG. 24, with a cassette inserted and the cover in the closed position; and

FIG. 29 is and enlarged view of part of FIG. 28 showing a cassette aligning feature.

### DETAILED DESCRIPTION OF THE PREFERRED EMBODIMENTS OF THE DISCLOSURE

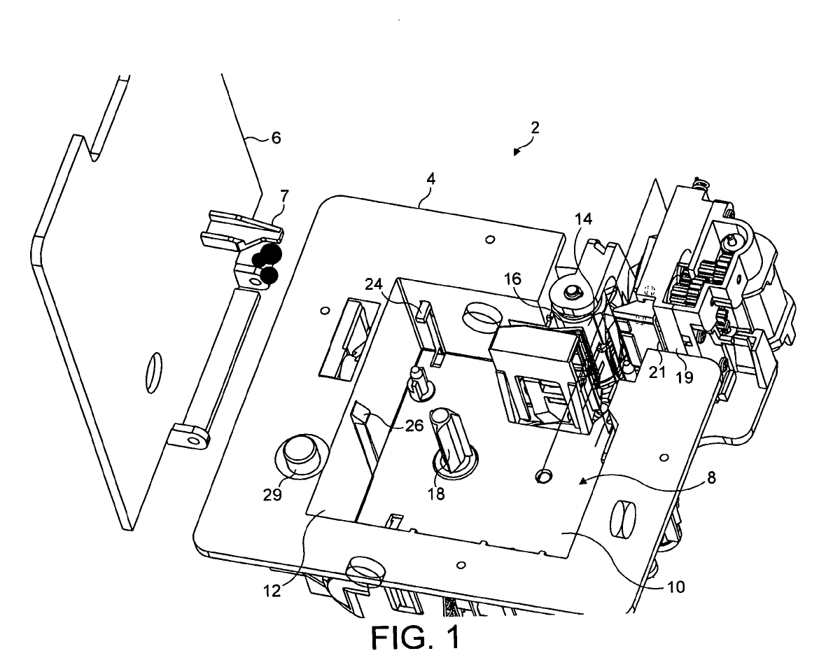

Referring to FIG. 1, the label printer 2 comprises a body 4, a lid (or cover) 6 and a cassette-receiving bay 8. The cassette-receiving bay 8 has an opening in a top portion of the body for vertical insertion of a cassette. The lid 6 is hinged for closing over the top opening. The lid 6 comprises a plunger part 7, which projects from the underside of the lid 6 for engagement with a print head actuation lever (to be described later). In an alternative embodiment, the lid (or cover), may be a detachable lid which is completely detachable from the body 4 of the label printer 2 when in an open position.

The cassette-receiving bay 8 comprises a recess forming an opening for receiving a cassette. The recess is formed by a base 10 and sides 12 extending from the base 10 to the top opening. A platen 14 and a printhead 16 are provided in the cassette-receiving bay 8. The printhead 16 is movable towards the platen 14 whereby, during printing, the printhead 16 co-operates with the platen 14, with tape passing therebetween for printing thereon. The platen 16 is driven by a motor (not shown) for propagating the tape during printing. An ink ribbon take-up sprocket 18 extends from the base 10 of the cassette-receiving bay 8 for cooperating with an ink ribbon take-up spool of a cassette when inserted into the cassette-receiving bay 8. The sprocket 18 is driven by a motor (not shown) for winding the ink ribbon around the ink ribbon take-up spool during printing. A slit 19 is provided in the body 4 of the label printer forming an exit through which the tape passes after printing. A cutting mechanism 21 is provided adjacent the exit slit 19 for cutting off the printed portion of tape to provide a printed label.

A first ejector element 24 is visible on a side-wall of the cassette-receiving bay 8. Also visible in FIG. 1 is a locking element 26 of a locking mechanism (which is not visible) on the left hand side of the cassette-receiving bay 8. An actuator button 29 is provided on the surface of the body 4 for actuating the locking mechanism.

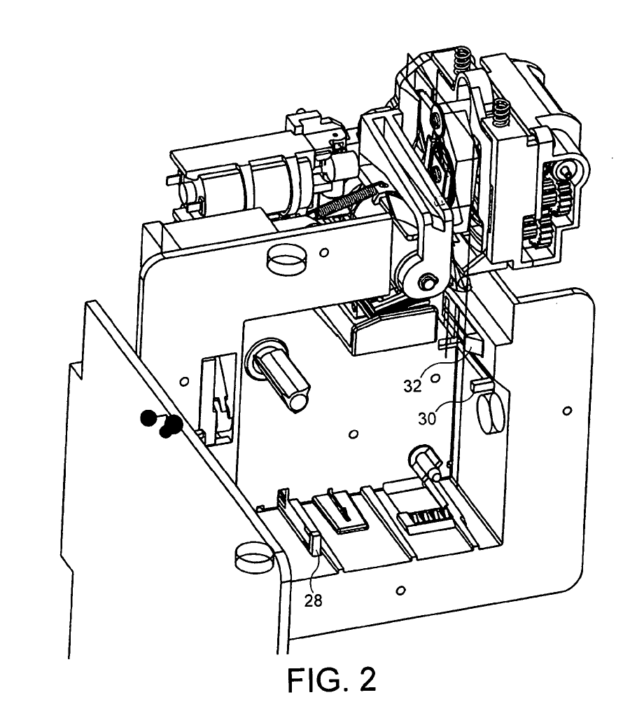

Referring to FIG. 2, a second ejector element 28 of a second ejector mechanism (which is not visible) is shown on the opposite side wall of the cassette receiving bay 8 to the first ejector element 24. A third ejector element 30 of a third ejector mechanism (which is not visible) is positioned on the right hand side of the cassette receiving bay 8. A second locking element 32 of the locking mechanism (which is not visible) is positioned on the right hand side of the cassette-receiving bay 8.

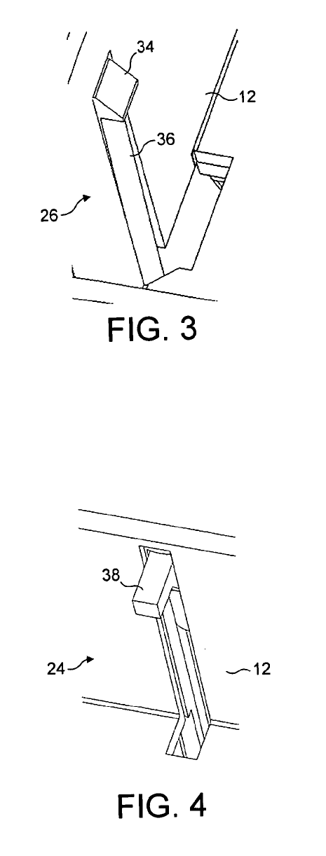

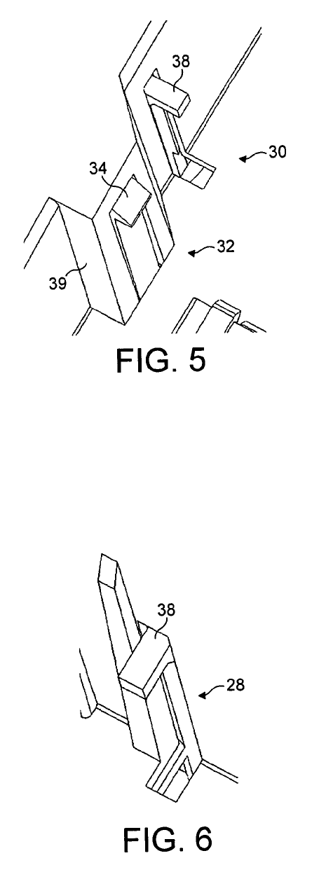

Referring to FIGS. 3, 4, 5 and 6, each of the locking and ejector elements 24, 26, 28, 30, 32 are provided at the sides of the cassette-receiving bay 8 and extend into the cassette-receiving bay 8 through openings in the sides for interaction with an inserted cassette.

Each locking element 26, 32 comprises a projection 34 and an elongate element 36 extending in a direction from the base 10 to the top opening of the cassette-receiving bay 8.

The projection 34 is at a top end of the elongate element 36 and extends towards a central portion of the cassette-receiving bay 8 through a corresponding opening in the side wall 12 of the cassette-receiving bay 8. Each projection 34 has a sloped upper surface for cooperating with a cassette inserted into the cassette-receiving bay 8 for moving the locking element from a locking position to an unlocked position. One of the side walls of the cassette-receiving bay 8 has a portion 39 projecting into the cassette-receiving bay 8 forming a guide for a corresponding recess in a cassette when inserted into the cassette-receiving bay 8. The locking element 32 is positioned in an opening in the guide 39 and extends therefrom into the cassette-receiving bay 8 thereby forming a combined guiding and locking arrangement.

Each ejecting element 24, 28, 30 extends from the side wall of the cassette-receiving bay 8 part way into the cassette-receiving bay 8 and has a free end unconnected to any other structural elements. The ejector elements 24, 28, 30 comprise an elongate element 38 extending in a perpendicular direction relative to the side wall through an opening in the side wall.

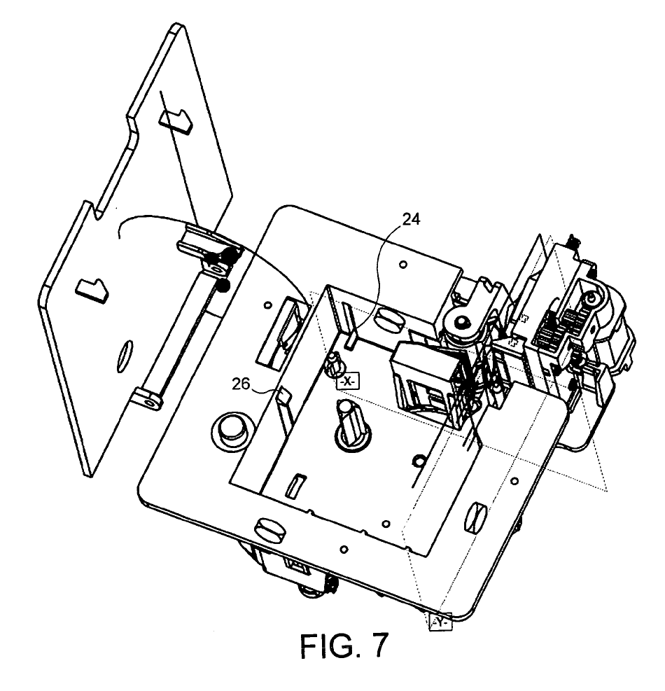

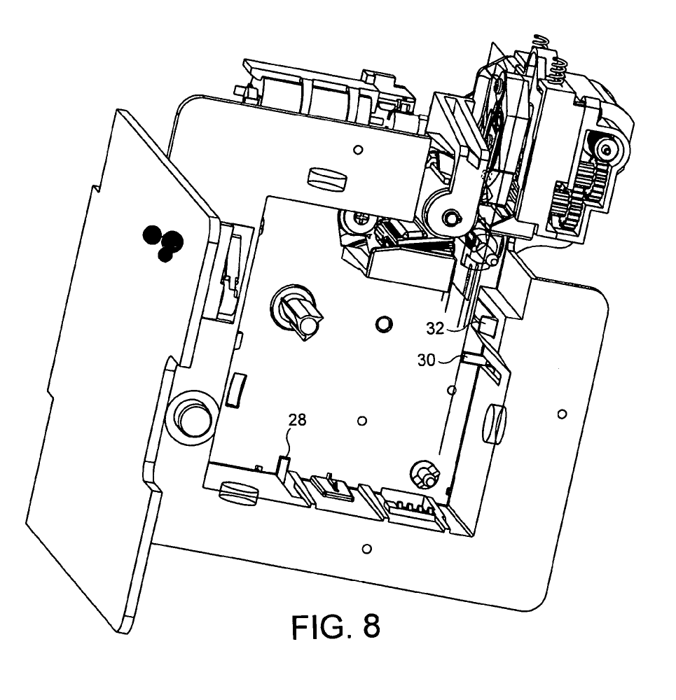

Referring to FIGS. 7 and 8, when a cassette is installed in the cassette-receiving bay 8, the first, second and third ejector elements 24, 28, 30 are pushed down to the base 10 and the first and second locking elements 26, 32 are in the locking position.

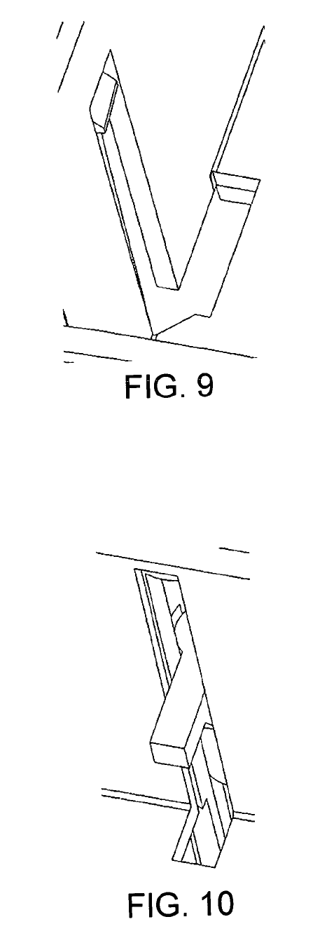

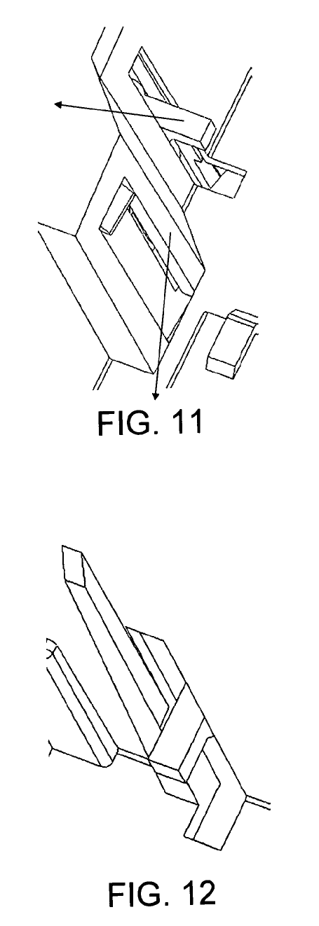

FIGS. 9, 10, 11 and 12 illustrate the positions of the locking and ejector elements 24, 26, 28, 30, 32 when the cassette is being inserted into the cassette-receiving bay 8. In FIGS. 9, 10, 11 and 12 the cassette is not shown for clarity.

During insertion, the cassette contacts the locking and ejector elements 24, 26, 28, 30, 32. The projections 34 of the locking elements 26, 32 have sloped upper surfaces such that as the cassette is inserted the locking elements 26, 32 are pushed backwards by the cassette into corresponding openings in the side walls 12. The locking elements 26, 32 are in their unlocked position. The locking elements 26, 32 are spring loaded to move into the locking position when the cassette is fully loaded as shown in FIGS. 7 and 8. The locking elements 26, 32 prevent the cassette from moving in an upward direction by interacting with locking features in the cassette. The ejectors 24, 28, 30 are spring loaded and cooperate with an underside of the cassette.

To eject a cassette, the ejector button 29 is actuated by a user pressing down on it, which, unlocks the mechanism by moving the locking elements 26, 32 backwards into their corresponding openings in the side walls 12 of the cassette-receiving bay 8. The cassette is thus released and the ejectors 24, 28, 30 push the cassette upwards for easy removal from the printer 2.

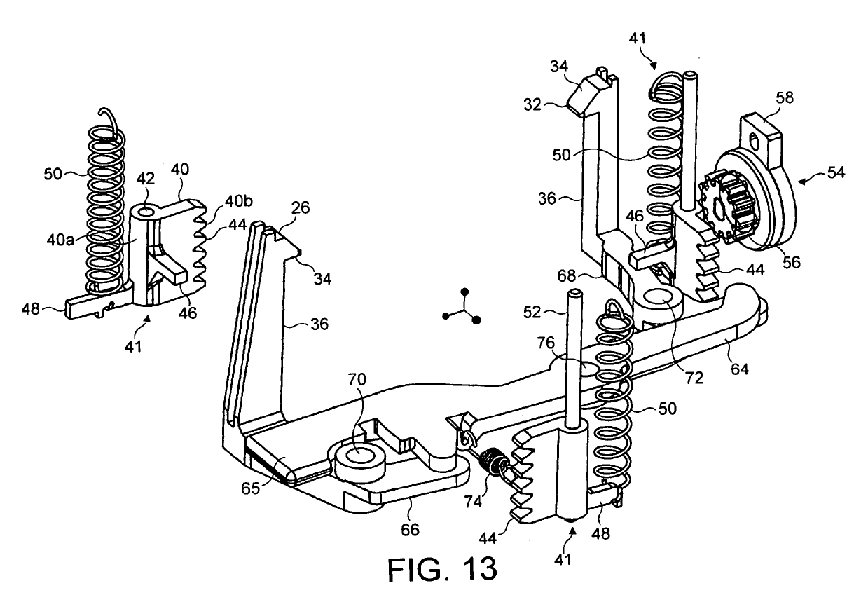

Referring to FIG. 13, the locking mechanism and the ejector mechanisms will now be described in more detail. The ejectors 41 each comprise a body portion 40. Adjacent to a first edge 40a thereof, the body portion 40 has hole 42 formed therethrough, the axis of the hole arranged so as to be parallel to the first edge 40a of the body portion 40. The hole 42 has a circular cross-section. Along a second edge 40b of the body portion 40, opposite the first edge 40a, the body portion 40 comprises a rack portion 44. An ejector element 46 extends perpendicularly from the plane of the body portion 40, which extends between the first and second edges 40a, 40b, from a point adjacent to the first edge 40a of the body portion 40, i.e. adjacent to the hole 42. The ejector element 46 is arranged so as to extend through a slit (not shown) in the side wall 12 of the cassette-receiving bay 8. Each ejector 41 further comprises a biasing member 48 at the bottom end of the first edge 40a of the body portion 40. The biasing member 48 extends in the plane of the body portion 40 perpendicular to the axis of the hole 42. The biasing member 48 is coupled to one end of an expansion spring 50, for biasing the ejector element 46 towards the top end of the corresponding slit (not shown) in the side wall 12 of the cassette-receiving bay 8. The top end of the slit in the side wall 12 is the end adjacent to the top opening of the cassette receiving bay 8, with the bottom end of the slit being that which is adjacent to the base 10 of the cassette receiving bay 8.

The body portion 40 of the ejector mechanism 41 is mounted on a shaft 52, which extends through the hole 42 in the body portion 40. A damper 54 is disposed adjacent to the rack portion 44 of the body portion 40. The damper 54 comprises a pinion (or gear) 56 which is rotatably mounted to a damper mount part 58.

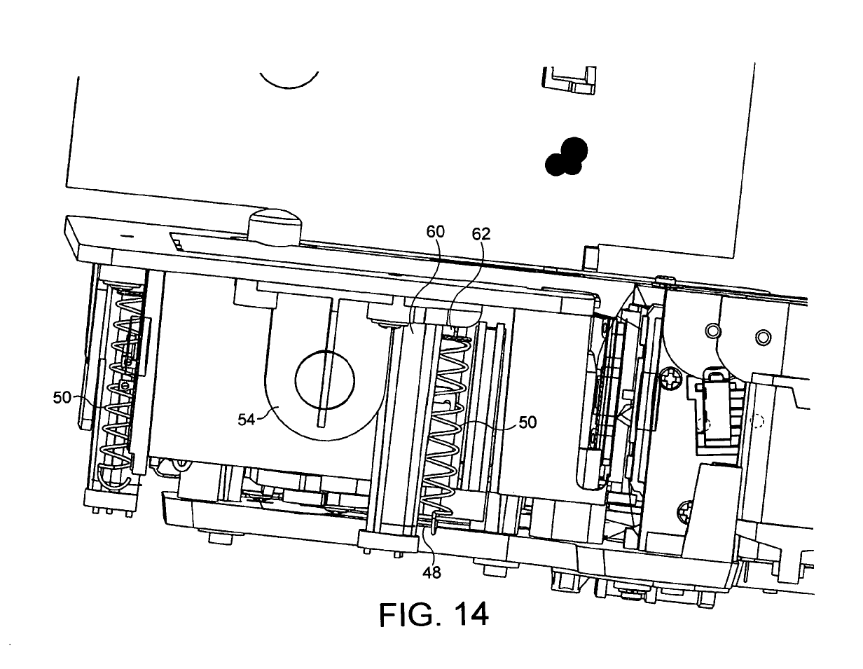

FIG. 14 shows an ejector mechanism 41 of the label printer 2. As can be seen from FIG. 14, the ejector mechanism 41 comprises and ejector housing 60. The ejector housing 60 is approximately cylindrical in shape. The shaft 52 of the ejector mechanism 41 is disposed so as to be co-axial with the ejector housing 60. Accordingly, the body portion 40 is slidably mounted within the ejector housing 60, by means of the shaft 52 passing through the hole 42 formed at the first end 40a of the body portion 40. The ejector housing 60 comprises a first elongate opening along its length (not shown) The first elongate opening of the ejector housing 60 is aligned with a corresponding slit formed in a side wall 12 of the cassette receiving bay 8. The ejector element 46 of the ejector mechanism 41 protrudes into the cassette-receiving bay 8 through the first elongate opening and through the slit in the side wall 12, so as to interact with a cassette. The ejector housing 60 further comprises a second elongate opening (not shown) through which the biasing member 48 of the body portion 40 extends. As can be seen in FIG. 14, the biasing member 48 is attached to the lower end of the spring 50, i.e. the end of the spring 50 closest to the base 10 of the cassette receiving bay 8. The ejector housing 60 comprises a fixed extension 62 disposed at an upper end of the housing 60, adjacent to the top of the second elongate opening. The upper end of the spring 50 is attached to the fixed extension 62. Accordingly the spring 50 acts so as to bias the body portion 40 of the ejector mechanism 41 towards the upper end of the housing 60. The ejector housing 60 further comprises a third elongate opening (not shown), through which the rack portion 44 at the second edge 40b of the body portion 40 extends. The third elongate opening is aligned relative to a damper 54, such that the rack portion 44 meshes with the pinion 56 of the damper 54.

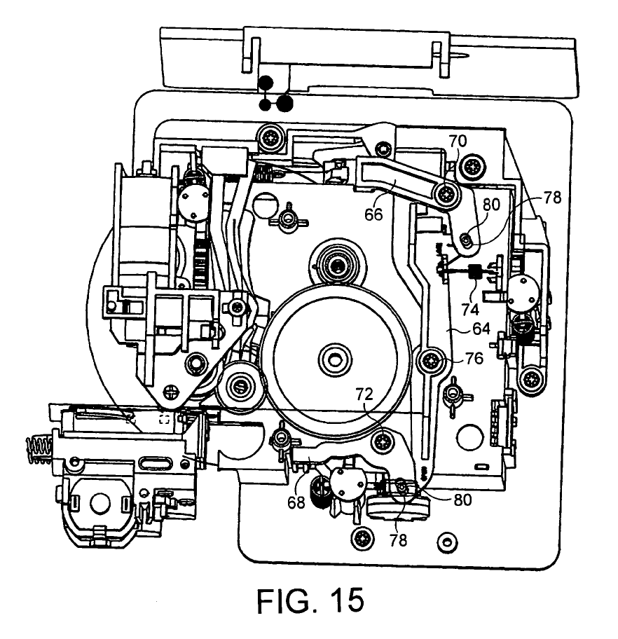

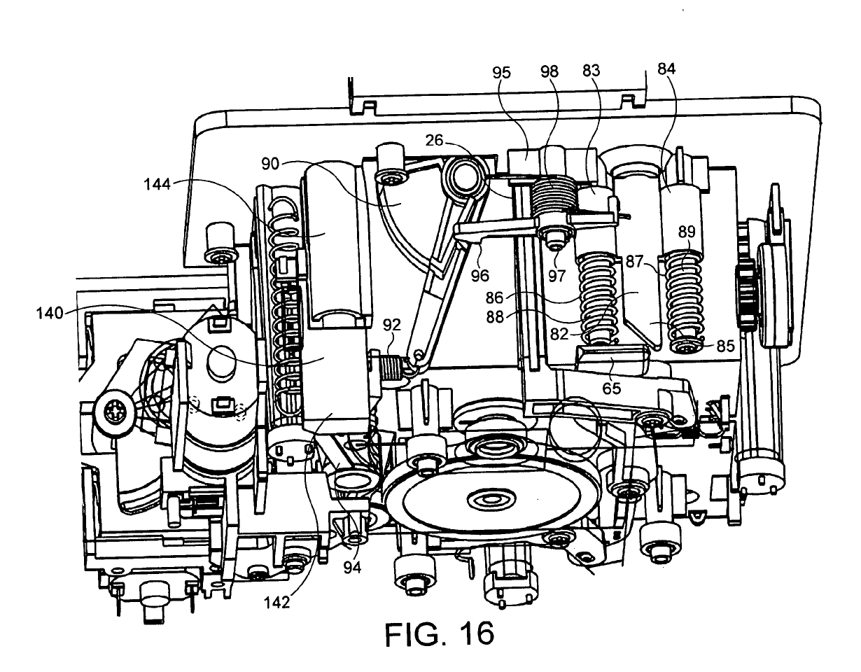

Referring to FIGS. 13 and 15, the locking mechanism will now be described in more detail. The locking mechanism comprises the two locking elements 26, 32. As described previously, the locking elements 26, 32 each comprise an elongate element 36 and a projection 34. Each projection 34 has a sloped upper surface for cooperating with a cassette inserted into the cassette-receiving bay 8 for moving the locking elements 26, 32 from the locking position to the unlocked position. The locking elements 26, 32 are coupled together by an actuating bar 64. Each of the locking elements 26, 32 is coupled to the actuating bar 64 by a respective coupling member 66, 68 extending in a perpendicular direction relative to the locking element. The locking elements 26, 32 have respective centres of rotation 70, 72 on opposite sides of the actuating bar 64 to each other. The centres of rotation 70, 72 comprise pivot points attached to the printer body 4. A return spring 74 is provided for biasing the locking elements 26, 32 towards the locking position. The actuating bar 64 has a centre of rotation 76, which also comprises a pivot point attached to the printer body 4. The first locking element 26 is rotatably coupled to the actuating bar 64 by means of a slot 78, provided in the distal end of the coupling member 66 relative to the first locking element 26, which cooperates with a pin 80 provided at a first end 65 of the actuating bar 64. The second locking element 32 is similarly rotatably coupled to a second end of the actuating bar 64.

Referring FIG. 16, the ejector button 29 is disposed adjacent to the cassette-receiving bay 8, so as to be pressed by a user to eject a cassette from the cassette-receiving bay 8 when the lid 6 is open and a cassette is inserted. The ejector button 29 comprises an actuator part 82. The upper end of the actuator part (not shown) has a circular cross-section and extends through an opening in the upper surface of the label printer 2, such that it can be pressed by a user. The lower end of the actuator part 82 comprises first and second tubular portions 83, 84 and a flange part 85 disposed therebetween. The flange part 85 of the ejector button actuator part is angled at the lower end thereof, at an angle of approximately 45°. First and second button guide shafts 86, 87 are mounted to the printer body 4 and pass through the first and second tubular portions 83, 84 of the actuator part 82, respectively, so as to guide the motion of the actuator part 82 when pressed by a user. First and second eject button springs 88, 89 are disposed on the first and second guide shafts 86, 87, respectively, so as to bias the actuator part 82 towards the top of the label printer 2.

The label printer 2 further comprises a print head actuation lever 90, for moving the print head 16 into an operative position for printing. The print head actuation lever 90 is pivotally mounted at a first end thereof to the side of printer body 4. The print head actuation lever 90 is disposed below an opening in the top surface of the printer body 4. Accordingly, when the lid 6 is closed, the plunger part 7 extends through the opening and pushes on the print head actuation lever 90, so as to make it rotate in an anti-clockwise direction (as viewed in FIG. 16).

The second end of the print head actuation lever 90 is coupled, via an expansion spring 92, to the proximal end of a print head support member 94. The print head 16 is mounted at the distal end of the print head support member, and the print head support member is pivoted about a point between the proximal and distal ends thereof.

The label printer 2 further comprises a print head actuation lever lock 95, which is disposed adjacent to the ejector button actuator part 82. The print head actuation lever lock 95 comprises a hook 96, rotatably mounted to a boss 97 which projects downward from the printer body 4. A torsion spring 98 is provided on the boss 97 so as to bias the hook 96 in an anti-clockwise direction (as viewed from below the label printer).

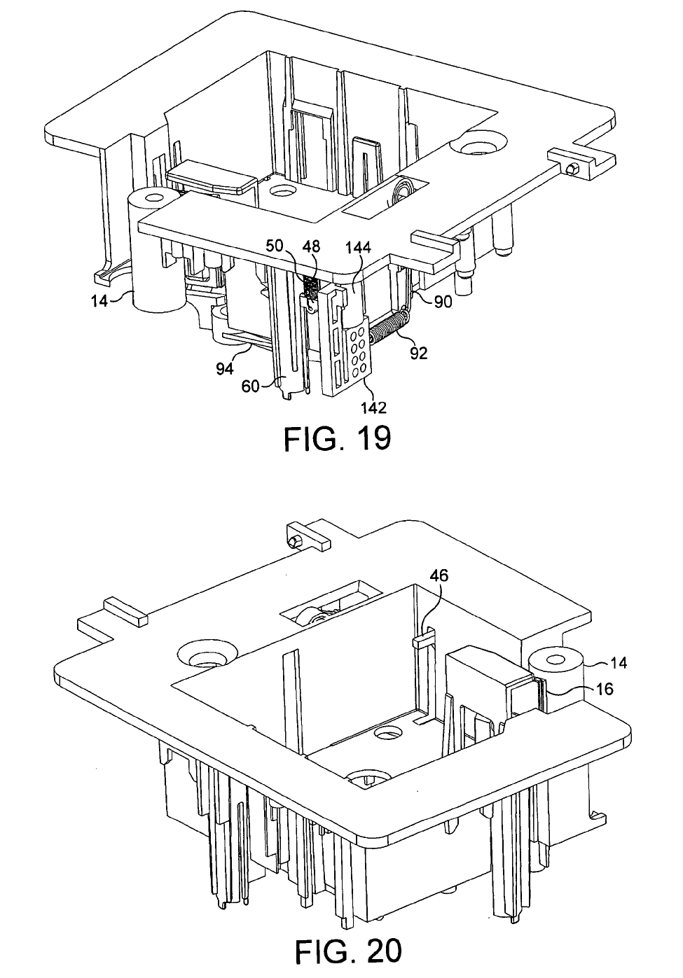

Referring to FIGS. 16 to 23, the label printer 2 further comprises a print head stop mechanism 140. The print head stop mechanism 140 comprises a stopper member 142 slidably mounted within a print head stop housing 144. The print head stop housing 144 projects downward from the underside of the printer body 4, and is disposed adjacent to the print head actuation lever 90. The stopper member 142 is slidably mounted within the print head stop housing 144. A compression spring 143 within the print head stop housing 144, biases the stopper member 142 in a downward direction. The base 142a of the stopper member 142 extends beneath the proximal end of the print head support member 94 in a plane parallel to the base 10 of the cassette-receiving bay 8.

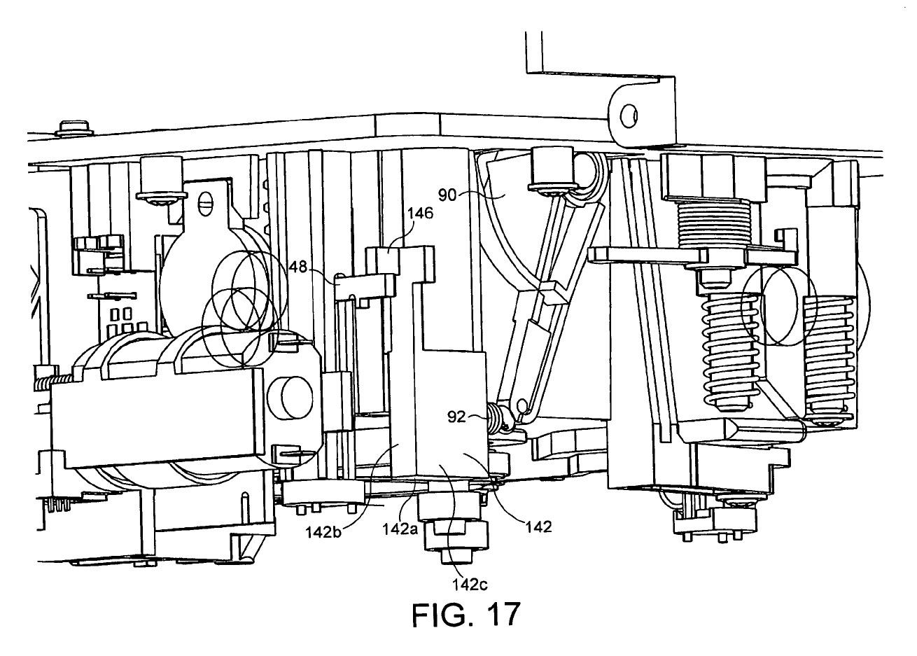

Referring to FIG. 17, the base 142a, rear wall 142b and side wall 142c of the stopper member define region in which the proximal end of the print head support member 94 can be accommodated. A lip 145 projects upwards from the base 142a, at the opposite end of the base 142a to the rear wall 142b. A projection 146 extends from the upper end of the stopper member 142 into the path of travel of the biasing member 48 of the ejector mechanism 41 for the first ejector element 24. The projection 146 is arranged to as to be above the biasing member 48 in the direction of travel of the ejector element 24.

The operation of the above described locking mechanism and ejector mechanisms will now be described. When there is no cassette inserted in the cassette-receiving bay 8, the spring 50 of each ejector mechanism 41 is in an unextended state and, accordingly, each ejector element 24, 28, 30 is disposed at the top end of the corresponding slot in the side wall 12 of the cassette-receiving bay 8. The locking elements 26, 32 of the locking mechanism are biased towards the locking position, by means of the return spring 74 acting on the actuating bar 64.

When a cassette is inserted into the cassette receiving bay 8, the base of the cassette presses down on each ejector element 24, 28, 30. This, in turn, causes the body portion 40 of each ejector to move downwards along the shaft 52 and causes the spring 50 to extend. As the body portion 40 moves downwards, the rack portion 44 is meshed with the pinion 56 of the damper 54. Accordingly, the pinion 56 of the damper 54 is rotated as the cassette is inserted and provides a resistance to the force applied to the cassette by a user who inserts the cassette into the cassette receiving bay 8. The resistance provided by the pinion 56 engaging with the rack portion 44 is preferably selected so as not to be so great that a user requires excessive force to insert a cassette into the cassette-receiving bay 8, which could damage components of the ejector mechanisms. When the cassette has been inserted fully into the cassette-receiving bay, the locking elements 26, 32 engage with corresponding portions of the cassette, so as to hold the cassette in the cassette-receiving bay 8 against the force exerted on the base of the cassette by the ejector elements 24, 28, 30.

When the eject button 29 is pressed, the downward movement of the actuating part 82 causes the angled flange part 85 to push against the first end 65 of the actuating bar 64. Referring again to FIG. 15, the actuating bar 82 rotates around its centre of rotation 76 in an anti-clockwise direction (as viewed). Accordingly, the coupling member 66 of the first locking element 26 rotates clockwise around centre of rotation 70, thereby moving the first locking element 26 to the unlock position. At the same time, the coupling member 68 of the second locking element 32 rotates anti-clockwise around centre of rotation 72, thereby moving the second locking element 32 to the unlock position.

With the locking elements 26, 32 in the unlock position, the cassette is free to move under the force exerted by the ejector elements 24, 28, 30. As the expansion springs 50 of the ejector mechanisms 41 contract, the ejector elements 24, 28, 30 move up their corresponding slits in the side walls 12 of the cassette-receiving bay 8 and push the cassette out of the cassette receiving bay 8. At the same time, the rack portion 44 of each ejection mechanism 41 is meshed with the pinion 56 of the corresponding damper 54. Accordingly, the engagement of the rack portion 44 and the pinion 56 provides a resistance to the upward movement of the ejector elements 24, 28, 30. Thus, by employing a damper 54, the acceleration of an ejector element in the upward direction under the force of the expansion spring 50 is reduced. The cassette is thus gradually ejected from the cassette-receiving bay 8. The degree of resistance provided by the pinion 56 of the damper 54 may be determined by the viscosity of oil used to lubricate the pinion with respect to the damper mount part 58.

With the above described arrangement, it is possible to gradually eject a cassette from the cassette-receiving bay 8 such that it does not ‘spring’ out at high speed. This prevents damage to the cassette which may be caused by sudden and rapid ejection. Furthermore, the stress on the components of the ejector mechanism, such as the biasing member 48, is reduced by employing a damper 54. Additionally, a gradually ejected cassette does not cause alarm to a user who ejects the cassette.

Although the above-described ejector mechanism comprises ejector elements which extend through slits in the sidewalls of the cassette receiving bay so as to interact with a cassette disposed therein, it will be appreciated by those skilled in the art that the damper arrangement could equally be applied in respect of other configurations of cassette ejection mechanisms. For example, the ejector element could extend through a hole in the base of the cassette receiving bay.

The operation of the print head stop mechanism 140 will now be described in more detail.

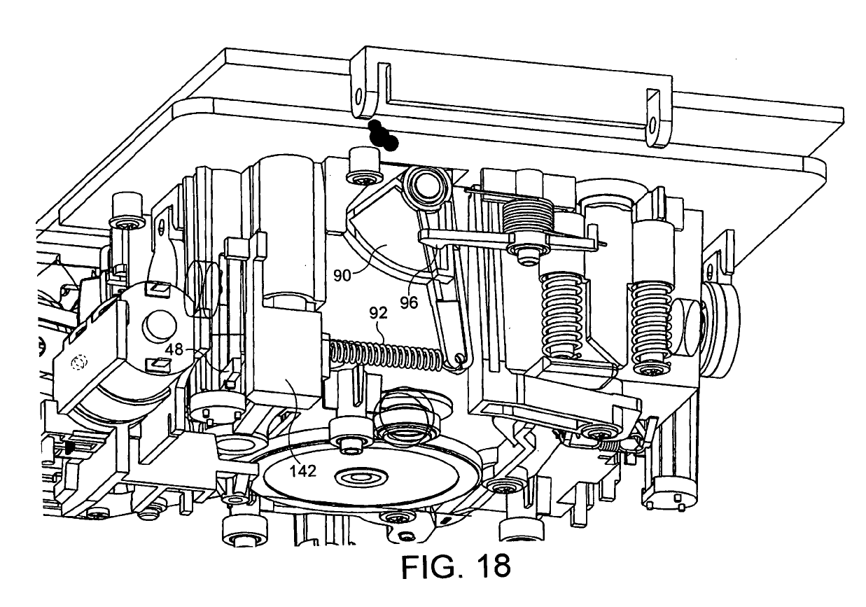

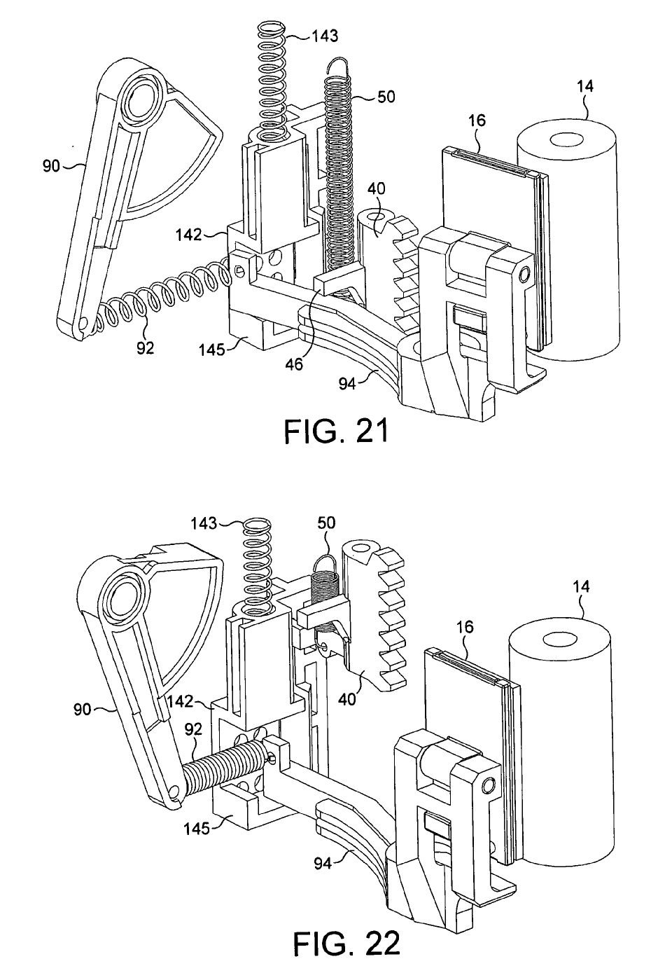

FIGS. 18 and 21 illustrate a situation where a cassette is inserted into the cassette-receiving bay 8 and the lid 6 is closed. When the cassette is inserted, the first ejector element 24 is pushed down to the base 10 of the cassette receiving bay 8. Accordingly, the biasing member 48 of the ejector mechanism 41 is moved down to the bottom of the second elongate opening of the ejector housing 60. Movement of the projection 146 of the stopper member 142 is unrestricted and, accordingly, the stopper member 142 moves downwards under the force of the spring 143 in the print head stop housing 144.

With the stopper member 142 in its lower position, the proximal end of the print head support member 94 is free to move past the lip formed on the base 142a of the stopper member 142. Accordingly, when the lid 6 is closed, the print head actuation lever 90 is rotated anti-clockwise (as viewed in FIG. 18) by the plunger part 7. By means of the spring 92 connecting the print head actuation lever 90 to the proximal end of the print head support member 94, the print head support member 94 is rotated until the printhead 16, disposed at the distal end of the print head support member 94, contacts the platen 14. As the pressure of the print head 16 pressing on the platen 14 increases, the spring 92 extends so as to prevent damage occurring to either of the platen 14 or the print head 16. As the print head actuation lever 90 rotates, it engages with the hook 96 of the print head actuation lever lock 95. The hook 96 prevents the print head actuation lever 90 from rotating back in a clockwise direction under the force of the spring 92. Thus, a constant pressure is applied to the platen 14 by the print head 16.

When the eject button 29 is pressed and the first locking element 24 is moved into the unlock position, the first locking element 24 presses on the hook 96 and lifts the hook 96 so that it disengages from the print head actuation lever 90. A return spring (not shown) coupled to the print head support member 94 causes the print head support member 94 to rotate so that the print head 16 is separated from the platen 14. The cassette is then ejected from the cassette-receiving bay 8 as described above.

Referring to now FIGS. 17 and 22, when there is no cassette inserted into the cassette-receiving bay 8 and the lid 6 is open, the first ejector element 24 is pushed up towards the top opening of the cassette-receiving bay 8 by the spring 50 (not shown in FIG. 17) acting on the biasing member 48. The biasing member 48 moves up to the top end of the second elongate opening of the ejector housing 60. The biasing member 48 pushes on the projection 146 of the stopper member 142 causing the stopper member 142 to be lifted upwards against the biasing force of the spring 143 in the print head stop housing 144. With the stopper member 142 in its upper position the lip 145 formed on the upper surface of the base wall 142a of the stopper member 142 intersects the path of travel of the proximal end of the print head support member 94.

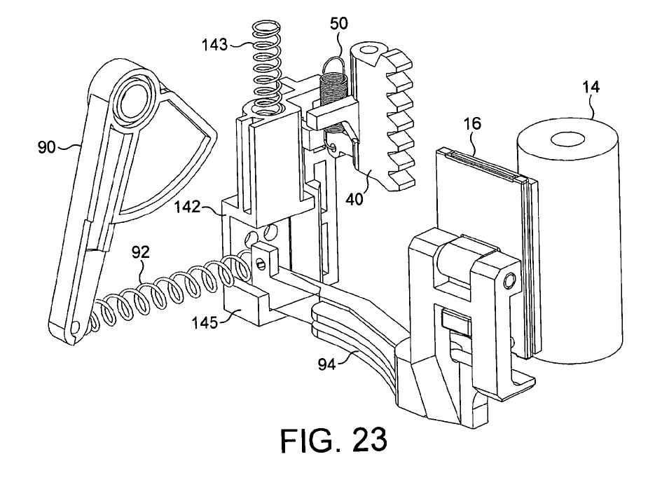

Referring to FIG. 23, when the lid 6 is closed and the print head actuation lever 90 is rotated, the lip 145 of the stopper member 142 prevents the print head support member 94 from rotating. Thus, the print head 16 is kept out of contact with the platen 14 in the situation where the lid 6 is closed but no cassette is inserted.

The above-described print head stop mechanism has the advantage that a separate print head stop actuating means is not required since the print head mechanism is actuated by the movement of the ejector mechanism. Accordingly, a print head stop mechanism according to the present disclosure allows a label printer to be constructed having a smaller size and using fewer components.

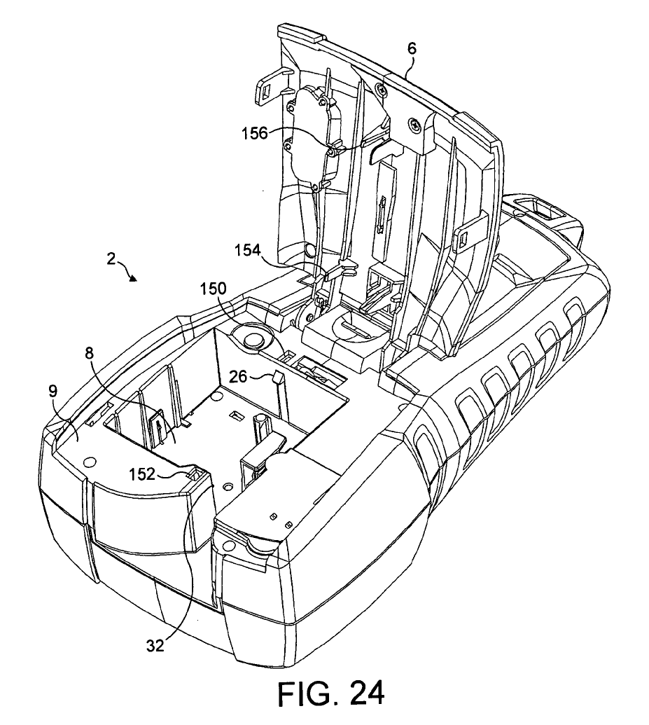

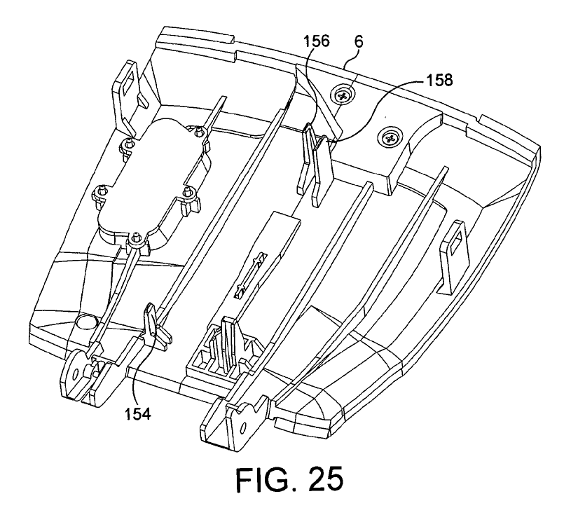

An alternative embodiment of a label printer according to the present disclosure will now be described with reference to FIGS. 24 to 29.

Referring to FIG. 24, the label printer 2 comprises a surface 9 which extends perpendicularly from the top opening of the cassette receiving bay 8. First and second openings 150, 152 in the surface 9 are disposed at locations adjacent to the first and second locking elements 26, 32 respectively. The lid 6 comprises first and second projections 154, 156 which correspond to the first and second openings 150, 152 respectively and are arranged so as to extend through the first and second openings 150, 152 when the lid 6 is in the closed position.

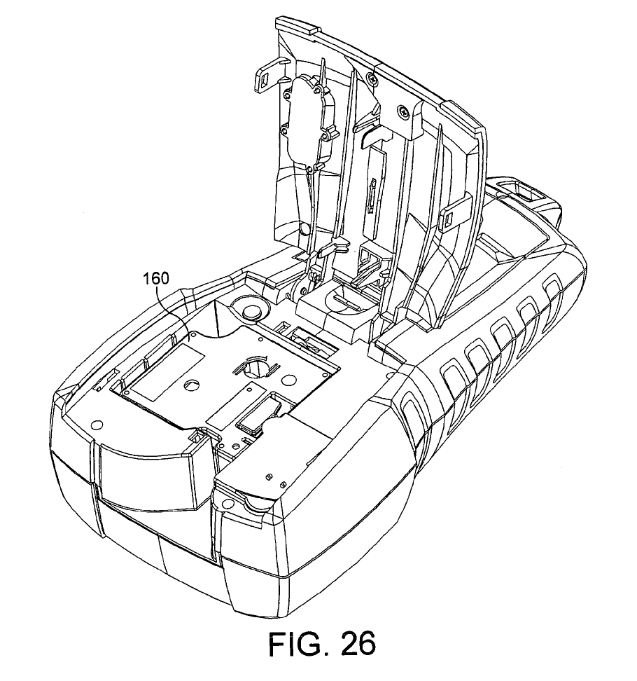

Referring to FIG. 26, when a cassette 160 is inserted into the cassette-receiving bay 8 of the label printer, the cassette is locked in place by means of the first and second locking elements 26, 32 as described previously.

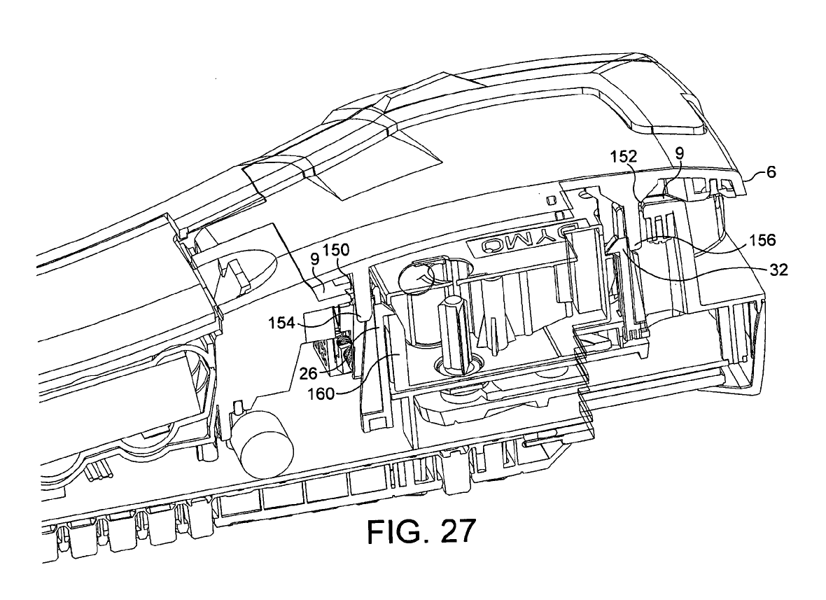

Referring to FIG. 27, when the lid 6 of the label printer 2 is in the closed position, the first projection 154 on the lid 6 extends through the first opening 150 in the surface 9 of the label printer so as to occupy a space adjacent to the first locking element 26. Similarly, when the lid 6 of the label printer 2 is in the closed position, the second projection 156 on the lid 6 extends through the second opening 152 in the surface 9 of the label printer so as to occupy a space adjacent to the second locking element 26.

Accordingly, with the above described arrangement, the first and second locking elements 26, 32 are prevented from moving to the unlocking position when the lid 6 is closed, due to the close proximity of the respective first and second projection 154, 156 of the lid 6. Thus, in the event that the label printer is subjected to a sudden impact, i.e. if it is dropped by a user onto a hard surface, the cassette 160 is maintained in the correct position for printing because any movement of the locking elements 26, 32 is prevented.

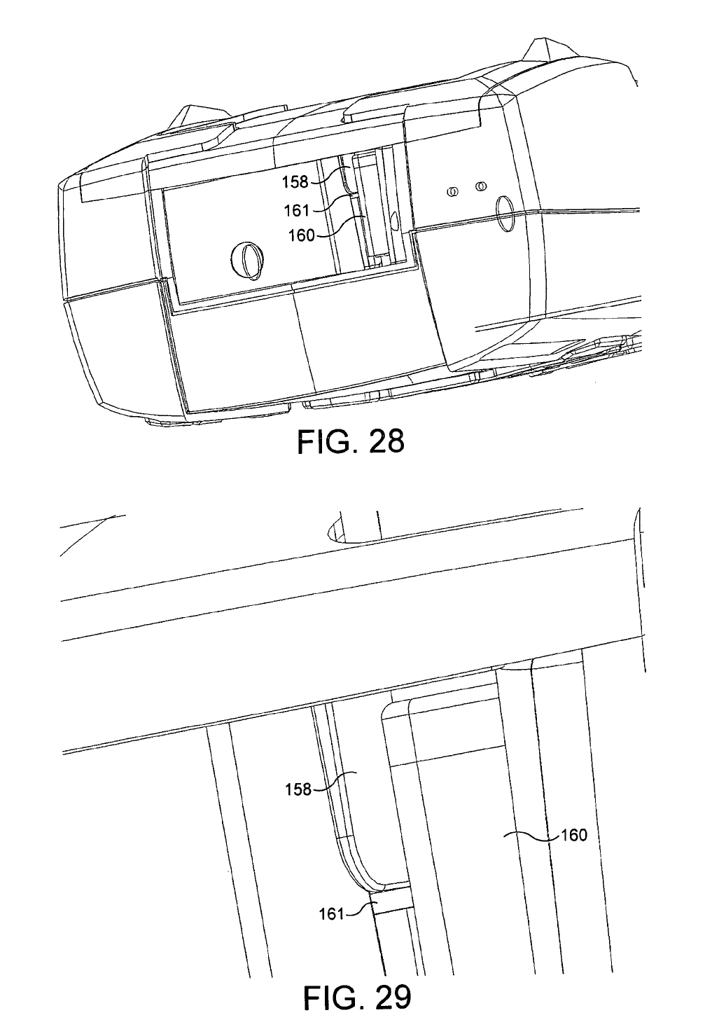

Referring to FIGS. 28 and 29, the lid 6 may comprise a third projection 158. The third projection 158 is arranged so as to cooperate with a corresponding projection 161 which extends perpendicularly from a side wall of the cassette 160. Accordingly, when the lid 6 is in the closed position, the third projection 158 abuts against the projection 161 of the cassette, so as to maintain the cassette 160 in the correct position for printing.

It will be appreciated by those skilled in the art that the teachings of the present disclosure may equally be applied to a printer having a fixed print head and a movable platen. It will also be appreciated by the person skilled in the art, that the teachings of the present disclosure may be applied equally to a label printer in which the image receiving medium is a continuous tape and to one in which the image receiving medium is a plurality of die-cut labels arranged on a continuous backing layer.

While this disclosure has been particularly shown and described with reference to preferred embodiments, it will be understood to those skilled in the art that various changes in form and detail may be made without departing from the scope of the disclosure as defined by the appendant claims.

1-26. (canceled)

27. A label printer comprising:
a cassette-receiving bay adapted to receive a cassette which contains an image receiving medium, said cassette-receiving bay having a base, an opening opposite the base, and side walls extending between the base and the opening;
a cover member provided on the cassette-receiving bay, said cover member movable between an open and closed position;
a locking mechanism comprising first and second locking elements each extending into the cassette receiving bay from one of the side walls for locking a cassette in the cassette receiving bay, wherein said first and second locking elements are movable between a locking position and an unlocked position; and
wherein said cover member comprises first and second projecting members extending therefrom and arranged such that each of the first and second projecting members are disposed adjacent to respective locking elements when said cover is in said closed position, thereby preventing said locking elements from being moved to the unlocked position when said cover is in said closed position, and the first and second locking elements being linked by an actuator mechanism positioned below the base of the cassette-receiving bay so as to synchronize movement of the first and second locking elements.

28. A label printer according to claim 27, wherein the label printer comprises a surface extending substantially perpendicular to the sidewalls of the cassette receiving bay, said surface comprising at least one opening therein for receiving said first and second projecting members when said cover member is in said closed position.

29. A label printer as set forth in claim 28, wherein said surface comprises first and second openings for respectively receiving said first and second projecting members.

30. A label printer according to claim 27, wherein said first and second locking elements extend from different side walls.

31. A label printer according to claim 27, wherein said first and locking elements extend from opposite side walls.

32. A label printer comprising:
cassette receiving means for receiving a cassette which contains image receiving means for receiving an image, said cassette receiving means having a base, an opening opposite the base, and side walls extending between the base and the opening;
cover means provided on said cassette receiving means for covering said cassette receiving means, said cover means movable between an open and closed position;
locking means comprising first and second locking means each extending into the cassette receiving means from one of the side walls for locking a cassette in the cassette receiving means, wherein said first and second locking means are movable between a locking position and an unlocked position; and
wherein said cover means comprises first and second projecting means for projecting from said cover means and arranged such that each of the first and second projecting means are disposed adjacent to respective locking means when said cover means is in said closed position, thereby preventing said locking means from being moved to the unlocked position when said cover means is in said closed position, and the first and second locking means being linked to actuating means positioned below the base of the cassette receiving means for actuating said locking means, so as to synchronize movement of the first and second locking means.

33. A printing system comprising a label printer as claimed in claim 27 and a label cassette.

34. A printing system comprising a label printer as claimed in claim 32 and a label cassette.
